(19) United States
(12) Patent Application Publication
(10) Pub. No.: US 2026/0369887 A1
(43) Pub. Date: Nov. 19, 2026

(54) ANTENNA ARCHITECTURES FOR AR CAPABLE WEARABLE DEVICES

(71) Applicant: Snap Inc., Santa Monica, CA (US)

(72) Inventors: Jason Heger, Louisville, CO (US); Stoyan Hristov, Gilroy, CA (US); Ugur Olgun, Marina Del Rey, CA (US)

(21) Appl. No.: 19/673,750

(22) Filed: May 11, 2026

Related U.S. Application Data
(60) Provisional application No. 63/805,571, filed on May 14, 2025.

(51) Int. Cl. H01Q 9/06; H01Q 1/27; H01Q 5/307

(52) U.S. Cl. CPC H01Q 9/065; H01Q 1/273; H01Q 5/307

(57) ABSTRACT

Examples include a smart glasses incorporating a stripe antenna assembly for enhanced wireless communication and user interaction. The smart glasses can include at least one temple that carries a stripe antenna assembly comprising a first plurality of conductors arranged along its elongate length, each separated by gaps, and a second conductor positioned inwardly closer to the user. Impedance tuning components can be strategically positioned along the gaps and between the conductors to optimize performance across multiple frequency bands. The antenna assembly may integrate a capacitive touch sensor for detecting user gestures, such as taps and swipes, enabling intuitive control of device functions.

### PRIORITY CLAIM

This application claims the benefit of U.S. Provisional Application No. 63/805,571, filed on May 14, 2025, which is hereby incorporated by reference in its entirety.

### BACKGROUND

Trends in consumer electronics have consistently been towards greater miniaturization, while the functionalities of these devices demand increasingly ubiquitous and reliable wireless connectivity. Antenna systems forming part of such electronic devices (for example wearable devices) often struggle to meet the conflicting requirements for compactness and for reliable transfer of large amounts of data (e.g., video content captured by a pair of smart glasses). These difficulties are exacerbated in wearable devices, where available space for antenna systems is often at a minimum. Adding to design challenges, modern wireless communication standards necessitate an antenna architecture with multiple antenna elements, each of which has to be electrically isolated from one another to ensure little to no correlation between the different antenna elements. These antenna elements should be capable of simultaneous operation with high radiation efficiency on wide and far apart frequency bands.

### BRIEF DESCRIPTION OF THE DRAWINGS

The appended drawings merely illustrate a selection of examples of the present disclosure and cannot be considered as limiting its scope. To facilitate collation of numbered items in the description to the drawings, the first digit of each numbered item corresponds to the figure in which that item first appears. In the drawings:

FIG. 1 is a perspective view of an electronics enabled eyewear device having a frame and a pair of temples, according to an example.

FIG. 2 is a cross-section of one of the pair of temples of the eyewear device of FIG. 1, according to an exemplary example.

FIG. 3 is a perspective view of portions of the eyewear device of FIGS. 1 and 2 with portions of the one of the pair of temples removed showing a stripe antenna assembly, according to an exemplary example.

FIG. 4 is a schematic view of a portion of the stripe antenna assembly that can be utilized within one or more of the pair of temples, according to an exemplary example.

FIG. 5A is a plan view of an exemplary configuration of components of the one of the pair of temples with portions of a cover of the temple removed showing gaps utilized by folded dipole antenna similar to that of FIG. 3, according to an exemplary example.

FIG. 5B is a plan view of an opposing side of the one of the pair of temples of FIG. 5A showing the gaps utilized by the folded dipole antenna, according to an exemplary example.

FIG. 6 is a chart showing an impedance performance of the antenna of FIGS. 5A and 5B, according to an exemplary example.

FIG. 7 is a chart of the Voltage Standing Wave Ratio (VSWR) performance of the folded dipole antenna of FIGS. 5A and 5B, essentially providing the same information that FIG. 6 does but in a linear format and a wider frequency range.

FIG. 8 is a chart of radiation efficiency v. frequency of the folded dipole antenna of FIGS. 5A and 5B when in free space and worn, according to an exemplary example.

FIG. 9 is a schematic view of an example of a folded dipole antenna formed by components of one of a pair of temples, according to an exemplary example.

FIG. 10A is a plan view of another exemplary configuration of components of the one of the pair of temples with portions of a cover of the temple removed showing gaps utilized by a folded dipole antenna similar to those of FIGS. 3, 5A and 9, according to an example.

FIG. 10B is a plan view of the temple of FIG. 10A from another perspective.

FIG. 10C is an enlarged perspective view of a portion of the temple of FIGS. 10A and 10B.

FIG. 11 is a schematic view of an eyewear device having a folded dipole antenna, a diplexer and a capacitive touch sensor, according to an exemplary example.

### DETAILED DESCRIPTION

The subject matter disclosed herein generally relates to eyewear, and more specifically to electronics-enabled eyewear with wireless communication enabled onboard electronic components facilitated by one or more antennas and a transceiver. At least one antenna can be carried by the temple as further discussed herein. Additionally, the eyewear can include an antenna system that includes multiple antennas. Such an antenna system can be carried by the temple(s), or a combination of the temple(s) and the frame of the eyewear, for example. One contemplated antenna can include a stripe antenna having a folded dipole structure that includes a gap between conductive elements whose configuration is further discussed and illustrated herein.

As used herein, the term non-loop conductor/antenna (sometimes called an incomplete loop antenna herein) refers to dipole conductors/antennas and/or monopole conductor/antennas, and excludes loop antenna/conductors. Further, the disclosed antenna elements provided by the folded dipole antenna are to be understood as providing actively driven antenna elements, which are to be distinguished from passive ground plane elements such as that which is in some cases provided by printed circuit board (PCB) ground planes elements or extensions thereof. According to one example, the antenna systems disclosed can include a common transceiver configured for wireless communication and the antennas are connected to the transceiver and configured to receive (and transmit) various signals.

The antennas discussed may further include electronics (sometimes simply called impendence tuning components herein) configured to provide frequency-domain discrimination and/or other functionality. However, it is contemplated that the antenna(s) disclosed can be configured (e.g., sized, constructed and/or shaped) for two or more wireless communication (operation) modalities according to some examples. Thus, the antenna(s) can be configured to receive and/or transmit data at approved frequency ranges for 3G, 4G, 5G, 6G, etc. communication (generally between 699 MHz to 2200 MHz range), and can be configured to cover even wider frequencies if desired. Specific cellular bands supported can include n12, n13, n5, n8, n1, n2, n3, n66, etc. The antennas can be configured to receive and/or transmit data at other approved frequency ranges for Global Positioning System (GPS), such as bands L1 to L5 (e.g., between 1.2GHz range and 1.6GHz range), BLUETOOTH® (e.g., 2.4GHz) and/or Wi-Fi (e.g., 2.4, 5 or 6GHz), for example. However, it is contemplated that the antennas can operate at any desired range of microwave frequencies (from 300MHz to 30GHz).

As used herein, an active antenna element (or simply active element) is an actively driven antenna element that is a conductor for the antenna that radiates/receives EM signals. An antenna is a device used to transmit and/or receive radio waves. It converts electric currents into radio waves and vice versa. An antenna system is a plurality of antennas. An antenna provides the interface between radio waves propagating through space and electric currents moving in one or more metal conductors. In general, an antenna refers to the entire arrangement of metal conductors used for radiating or receiving radio waves. It can take on many different shapes and configurations. An antenna element (or active antenna element) is a basic building block of an antenna. It is a single radiating piece or section of an antenna. Antennas are often composed of multiple antenna elements working together to transmit/receive signals. An antenna element is a component(s) or part(s) of the overall antenna structure. The term “element” refers to one or more radiating pieces, whereas “antenna” refers more broadly to the overall system of components.

The antenna systems disclosed herein provides improved signal reception, improved radiation efficiency, improved polarization diversity, and other benefits when compared to existing antenna systems for handheld or wearable devices while being integrated effectively into a constricted space in existing electronically enabled eyewear designs.

As mentioned above, traditional antenna designs face significant challenges when implemented in augmented reality (AR) eyewear devices. The temples of such devices are typically narrow and positioned in close proximity to the user's head, creating a challenging environment for effective antenna operation. Conventional electric-type antennas such as IFA/ILA or DILAs struggle in this environment because when placed in the temple, RF currents travel in opposing directions toward the tip and front of the temple, effectively canceling each other and reducing radiation efficiency. Additionally, the skinny temple design provides insufficient metal to create a proper ground backing for alternative solutions like patch antennas. This limitation, combined with the need to maintain user comfort by avoiding heat generation near the skin, has necessitated innovative approaches to antenna design for AR eyewear.

In view of these and other challenges, a stripe antenna assembly (also called a folded dipole antenna herein) is described herein that represents a novel solution to these technical challenges. This design incorporates strategic gaps or “stripes” in the metal structure of the temple, with impedance tuning components distributed along these gaps. This approach actively manipulates energy distribution on the antenna structure, focusing radiation outward and away from the user's head. The present antenna designs utilize a continuous metal piece (such as a vapor chamber, flexible printed circuit or other suitable metal component) on the side closest to the head, which serves as both a functional component for heat dissipation or connectivity and as a shield to protect the user from radiation. The outer-facing side of the antenna features multiple conductive segments separated by gaps, with impedance tuning components placed strategically to control current distribution and frequency response.

According to further examples, beyond wireless communication, the stripe antenna design can be diplexed to serve as both an RF antenna and to operate with a capacitive touch sensor. This dual functionality allows the antenna structure to detect touch gestures such as taps and swipes when a user's finger bridges adjacent conductive segments, enabling intuitive control of device functions like muting speakers, skipping audio tracks, or managing voice calls without additional hardware components. This multi-purpose approach maximizes the utility of the limited space available in AR eyewear temples, integrating wireless communication and user interface functions into a single, efficient component system.

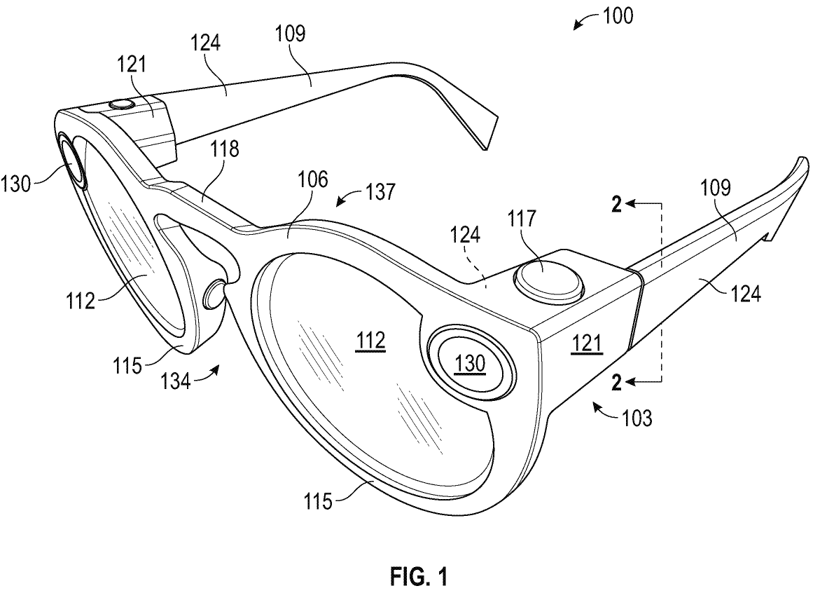

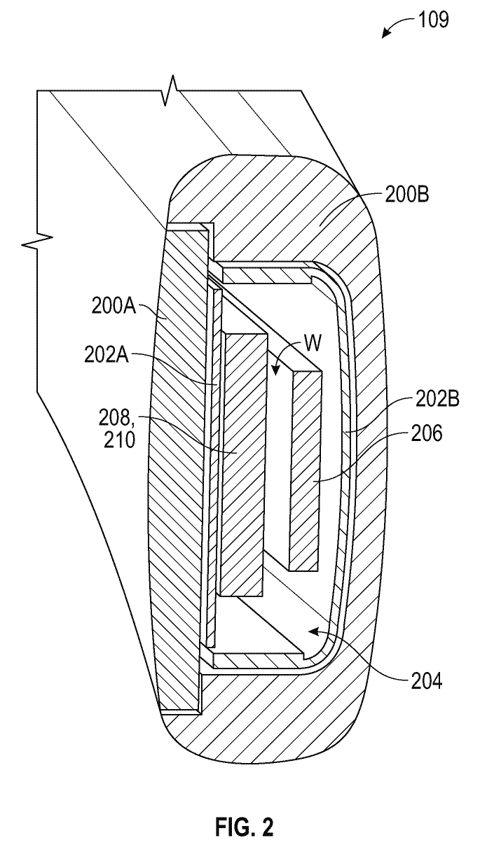

Various examples of an antenna system according to this disclosure will be described below with reference to an electronic device in the example form of an eyewear device that incorporates one or more of the disclosed antennas. Such eyewear device may include one or more cameras, indicator lights, memory, control circuitry, battery elements, and wireless communication circuitry among other components. An example of such an eyewear device in which different examples of the antennas can be incorporated will first be described with reference to FIG. 1, after which a series of different examples of antennas incorporating the different respective examples will be described with reference to FIGS. 2-11.

FIG. 1 shows an oblique front view of an electronic device in the example form of an electronics enabled eyewear device 100, also referred to as a pair of smart glasses. The eyewear device 100 includes a body 103 comprising a front piece or frame 106 and a pair of temples 109 moveably connected to the frame 106 for supporting the frame 106 in position on a user's face when the eyewear device 100 is worn. The frame 106 can be made from any suitable material such as plastics, composite, or metal, including any suitable shape memory alloy.

The eyewear device 100 has a pair of optical elements in the example form of a pair of optical lenses 112 held by corresponding optical element holders or lens holders in the form of a pair of lens rims 115 forming part of the frame 106. According to one example, the optical lenses 112 can be constructed of a chemically-strengthened lithium aluminosilicate (LAS) glass. The rims 115 are connected by a bridge 118. In other examples, of one or both of the optical elements can be a display, a display assembly, or a lens and display combination. The eyewear device 100 can, in such examples, comprise a virtual reality display or a see through augmented reality display.

The frame 106 includes a pair of end pieces (or chunks) 121 defining lateral end portions of the frame 106. In this example, at least some electronics components are housed in one or both of the end pieces 121. In some examples, the frame 106 can be formed of a single piece of material, so as to have a unitary or monolithic construction.

The temples 109 are coupled to the respective end pieces 121. In this example, the temples 109 are coupled to the frame 106 by respective hinges (articulating joint) so as to be hingedly movable between a wearable mode (as shown in FIG. 1) and a collapsed mode in which the temples 109 are pivoted towards the frame 106 to lie substantially flat against it. In other examples, the temples 109 can be coupled to the frame 106 by any suitable means. Each of the temples 109 includes a front portion that is coupled to the frame 106 and a suitable rear portion for coupling to the ear of the user, such as the curved earpiece illustrated in the example of FIG. 1. The temples 109 can be made from any suitable material(s) such as plastics, composite, and/or metal.

In this description, directional terms such as front, back, forwards, rearwards, outwards and inwards are to be understood with reference to a direction of view of a user when the eyewear device 100 is worn. Thus, the frame 106 has an outwardly directed front side 134 facing away from the user when worn, and an opposite inwardly directed rear side 137 side facing towards the user when the eyewear device 100 is worn. Similarly, the terms horizontal and vertical as used in this description with reference to different features of the eyewear device 100 are to be understood as corresponding to the orientation of the eyewear device 100 when it is level on the face of a user looking forwards. A horizontal or lateral direction of the eyewear device 100 thus extends more or less between the end pieces 121, while a vertical or upright direction of the eyewear device 100 extends transversely to the horizontal direction, such that the lenses 112 can be said to have a more or less vertical or upright orientation.

The eyewear device 100 has onboard electronic components 124 (sometimes called just electronics or components herein) including any one or combination of an antenna(s) (discussed further subsequently), a camera, a microphone, a speaker, a battery, a display device, a computing device, such as a computer, which can, in different examples, be of any suitable type so as to be carried by the eyewear body 103. In some examples, various components comprising the onboard electronics 124 are at least partially housed in one or both of the temples 109. Additionally, various components of the onboard electronics 124 are housed in the lateral end pieces 121 of the frame 106. As discussed above, the onboard electronics 124 includes one or more processors with memory, wireless communication circuitry, and a power source (this example being a rechargeable battery, e.g. a lithium-ion battery or solid state battery). The onboard electronics 124 comprises low-power, high-speed circuitry, and, in some examples, a display processor. Various examples may include these elements in different configurations or integrated together in different ways. As further discussed, the antenna systems described herein may be housed in one or both of the temples 109 and additionally in the frame 106. Thus, for example, certain electronics components such as the transceiver may in some examples be housed in the temple 109 as further discussed and illustrated subsequently.

As mentioned, the onboard electronics 124 includes a rechargeable battery. In some examples, the battery is disposed in one of the temples 109 such as near or at a tip of one of the temples 109 and is electrically coupled to the remainder of the onboard electronics 124.

The eyewear device 100 is camera-enabled, in this example comprising a camera 130 mounted in one of the end pieces 121 and facing forwards so as to be aligned more or less with the direction of view of a wearer of the eyewear device 100. The camera 130 is configured to capture digital still as well as digital video content. Operation of the camera 130 is controlled by a camera controller provided by the onboard electronics 124, image data representative of images or video captured by the camera 130 being temporarily stored on a memory forming part of the onboard electronics 124. In some examples, the eyewear device 100 can have a pair of cameras 130, e.g. housed by the respective end pieces 121.

The eyewear device 100 further includes one or more input and output devices permitting communication with and control of the camera 130. In particular, the eyewear device 100 includes one or more input mechanisms for enabling user control of one or more functions of the eyewear device 100. In this example, the input mechanism comprises a button 117 mounted on the frame 106 so as to be accessible on top of one of the end pieces 121 for pressing by the user.

The eyewear device 100 is, in this example, configured for wireless communication with external electronic components or devices, to which end the onboard electronics 124 is connected to one or more antennas integrated in the body 103 of the eyewear device 100.

Eyewear device 100 including optical lenses 112 (sometimes called displays herein) can have a construction as described variously in U.S. Patent Numbers United States Patent Nos. U.S. 9,726,904, titled EYEWEAR WITH CONDUCTIVE TEMPLE JOINT (filing date, Sep. 29, 2015); U.S. 9,482,882 titled EYEWEAR HAVING SELECTIVELY EXPOSABLE FEATURE (filed Apr. 15, 2015); and U.S. 9,482,883 titled EYEWEAR HAVING LINKAGE ASSEMBLY BETWEEN A TEMPLE AND A FRAME filed (Apr. 15, 2015), U.S. 10,877,293, titled EYEWEAR DEVICE LENS RETENTION MECHANISM, (filed Jan. 18, 2018), U.S. 11,063,338, titled HYBRID ANTENNA SYSTEM FOR WEARABLE DEVICES, (filed Jan. 24, 2019), U.S. 10,534,203, titled NEAR-FIELD ANTENNA FOR EYEWEAR, (filed Jul. 31, 2017), US Patent Application Publication Nos. 2019/0229395 and 2019/0033622, the contents of all of which are incorporated herein in their entirety.

Communication can be implemented using a wide variety of technologies. The I/O components may include communication components operable to couple the machine to a network or devices via a coupling. For example, the communication components include a network interface component or another suitable device to interface with the network. In further examples, communication components include wired communication components, wireless communication components, cellular communication components, near-field communication (NFC) components, BLUETOOTH® components (e.g., BLUETOOTH® Low Energy), WI-FI® components, and other communication components to provide communication via other modalities. The devices may be another machine or any of a wide variety of peripheral devices (e.g., a peripheral device coupled via a Universal Serial Bus (USB).

FIG. 2 shows a cross-sectional view of one of the temples 109 of the eyewear device 100 of FIG. 1. The temple 109 includes one or more covers 200A and 200B, temple supports 202A and 202B, a cavity 204, an antenna 206 and a heat transfer device 208.

The one or more covers 200A and 200B can be a plastic or other rigid material such as cellulosic plastic (e.g., cellulosic acetate), an eco-plastic material, a thermoplastic material, or the like. The one or more covers 200A and 200B can be an over-mold that encloses, embeds or otherwise encases the temple supports 202A and 202B. Put another way, the one or more covers 200A and 200B can form an outer cap for the temple 109 and can extend longitudinally along a length of the temple 109 from the articulated joint toward a second longitudinal end (tip) of the temple 109. The temple supports 202A and 202B can be another material that extends longitudinally within the one or more covers 200A and 200B. Together the temples supports 202A and 202B can form the cavity 204. The cavity 204 can be configured to carry some of the onboard electronics 124 (FIG. 1) as further discussed and illustrated herein including, for example, the one or more processors with memory, wireless communication circuitry, and a power source (battery).

The temple supports 202A and 202B can be configured as a core wire equivalent, frame, stiffener or other structural component to provide structural integrity to the eyewear body 103 (i.e. the temple(s) 109 and/or the frame 106). The temple supports 202A and 202B can be constructed of a relatively flexible conductive metal or metal alloy material such as one or more of an aluminum, an alloy of aluminum, alloys of nickel-silver, and a stainless steel according to some examples.

Optionally, the cavity 204 can additionally carry the antenna 206 and the heat transfer device 208, and a battery (not shown) therein. The antenna 206 can extend longitudinally along a portion of the longitudinal length of the temple 109 to at or adjacent the second longitudinal end. The antenna 206 can be relatively thin in a medial-lateral direction and can be constructed of a conductive metal or metal alloy material. Thus, the antenna 206 can be an electrically conductive component that extends longitudinally along at least a portion of a longitudinal length of the first of the pair of temples spaced in a width dimension W from the heat transfer device 208.

The heat transfer device 208 can extend generally parallel with the antenna 206 spaced in the width dimension W therefrom. Thus, the heat transfer device 208 can have an interfacing relationship with the antenna 206. Together, the heat transfer device 208 and the antenna 206 can form a radiating aperture (opening) that is orthogonal to a head of the user when the smart glasses are worn. This radiating aperture can form a slot S (an opening) between the heat transfer device 208 and the antenna 206. Some of the onboard electronic components 124 (FIG. 1) such as the one or more processors can comprise a heat source that generates heat during electrically powered operation. The heat transfer device 208 can act as a heat transfer pathway to transfer the heat generated by the onboard electronic components 124 (FIG. 1) away therefrom so as to reduce the likelihood of localized heating adjacent the onboard electronic components 124 (FIG. 1). As such, the heat transfer device 208 can be thermally coupled to the heat source to provide a heat sink for the heat source and can be coupled to another heat sink (e.g., the battery or another component) at a second portion thereof.

The heat transfer device 208 can be a core wire (constructed of a heat conductive material) or can be a vapor chamber such as a heat pipe as further discussed herein. According to some examples, the heat transfer device 208 (e.g., the vapor chamber) can function as the temple support such that a dedicated temple support 202A and/or 202B is not necessary in all examples.

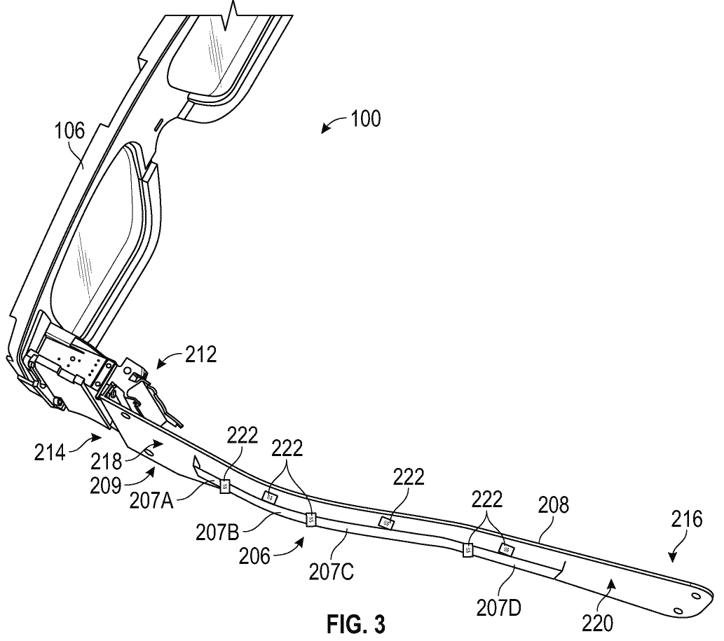

FIG. 3 shows part of the eyewear device 100 including part of the frame 106 and one of the temples 109. The one or more covers 200A and 200B of FIG. 2 are removed in FIG. 3 as are the temple supports 202A, 202B of FIG. 2. FIG. 3 illustrates the heat transfer device 208 extending from a hinge 212 (an articulating joint) at a first longitudinal end 214 of the temple 109 to a second longitudinal end 216. The antenna 206 can be positioned between the first longitudinal end 214 and the second longitudinal end 216 and can be in a spaced relationship from the heat transfer device 208. The antenna 206 can extend generally parallel with the heat transfer device 208. The antenna 206 at a first longitudinal end thereof can abut a printed circuit board (PCB) and communication device (e.g., a transceiver), for example. These onboard electronics are not specifically illustrated in FIG. 3 but are located at area 218 as indicated in FIG. 3. The antenna 206 at a second longitudinal end thereof can abut the battery (not shown in FIG. 3) located at area 220.

As shown in FIG. 3, the antenna 206 can be referred to herein as a stripe antenna assembly and can have a first plurality of conductive segments 207A, 207B, 207C and 207D that are each spaced apart (separated) from adjacent ones by a gap. As shown in FIG. 3, the antenna 206 can include impedance tuning components 222. As shown in FIG. 3, the one or more impedance tuning components 222 are positioned along the elongate length of the stripe antenna assembly (the antenna 206) at each gap between adjacent of the first plurality of conductive segments 207A, 207B, 207C and 207D and are additionally positioned to extend in a width dimension between one or more of the first plurality of conductive segments 207A, 207B, 207C and 207D and the heat transfer device 208 (used here in the antenna 206 as a second conductor).

The first plurality of conductive segments 207A, 207B, 207C, and 207D are active antenna elements and are metallic sections distributed along the elongate length of the temple 209. These conductive segments form part of the stripe antenna assembly and are separated by the gaps to enable operation at multiple frequency bands. The gaps between the conductive segments are strategically positioned to influence the current distribution and radiation pattern of the antenna 206. Each conductive segment 207A, 207B, 207C, and 207D can be designed to interact with impedance tuning components 222 to optimize the antenna's performance across various wireless communication standards, such as WiFi 6E, 4G LTE, and 5G NR.

Impedance tuning components 222 can be distributed along the length of the stripe antenna assembly such as by being positioned at the gaps between adjacent conductive segments 207A, 207B, 207C, and 207D and/or between the segments 207A, 207B, 207C, and 207D and the heat transfer device 208. The impedance tuning components 222, which may include various electronics components such as filters, are designed to manipulate the impedance characteristics of the antenna 206. By tuning the impedance, the impedance tuning components 222 can control the current distribution and radiation efficiency of the 206 antenna, supporting performance across desired frequency bands. The impedance tuning components 222 can also contribute to aperture tuning, which addresses undesired capacitance between the conductive segments and the heat transfer device 208.

The heat transfer device 208 can comprise a vapor chamber according to one example. The vapor chamber (e.g., a heat pipe) can extend longitudinally within the temple 109 as previously discussed. The vapor chamber can be thermally coupled to a heat source (e.g., the PCB and the communication device) at a first portion thereof and can be thermally coupled to a heat sink (e.g., the battery and/or a thermal interface material (TIMs)) such as at a second portion thereof. The heat transfer device can have a metal outer housing that can be electrically conductive and a hollow central cavity surrounded by an outer housing. The hollow cavity can contain a working fluid (e.g., deionized water). The working fluid can be evaporated to a vapor at the first portion adjacent the heat source. The vapor can travel the length of the vapor chamber as illustrated to the second portion. At the second portion adjacent the heat sink the vapor can condense back to fluid and the heat is released to the heat sink. The fluid can be absorbed back into a wick that extends substantially the length of the vapor chamber. The working fluid can travel the length of the wick back from the second portion to the first portion to repeat the cycle described above.

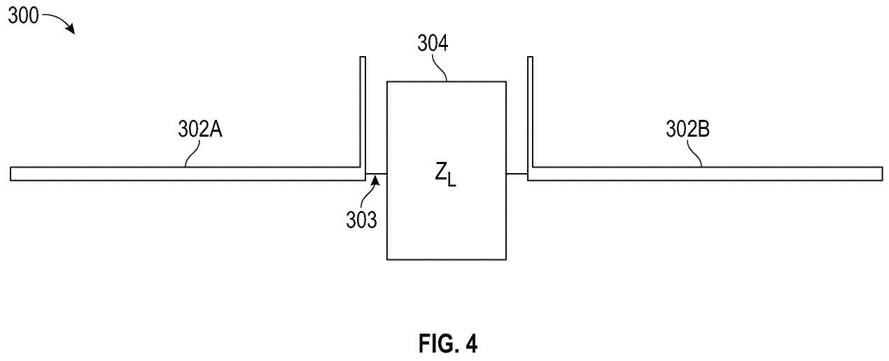

FIG. 4 shows a highly schematic rendering of a portion of a split antenna assembly 300 including a first conductive segment 302A, a second conductive segment 302B, a gap 303 and an impedance tuning component 304.

The split antenna assembly 300 can be configured to support wireless communication while reducing interference and energy absorption by the user's head. The split antenna assembly 300 includes multiple conductive segments (e.g., the first conductive segment 302A, second conductive segment 302B, etc.) separated by gaps (e.g., the gap 303), with impedance tuning components (e.g., impendence tuning component 304) strategically positioned to enhance the performance of the split antenna assembly 300 across various frequency bands. The split antenna assembly 300 can configured as a folded dipole antenna, utilizing geometry to achieve effective radiation efficiency and broad bandwidth. The split antenna assembly 300 interacts with other elements, such as the heat transfer device not specifically shown including a second conductor.

The first conductive segment 302A is an active antenna element of the split antenna assembly 300. It serves as a radiating element and is electrically coupled to the impedance tuning component 304 at the gap 303. Similarly, the second conductive segment 302B is spaced from the first conductive segment 302A by the gap 303 and is positioned adjacent to the first conductive segment 302A. Similar to the first conductive segment 302A, the second conductive segment 302B is an active antenna element and functions as a radiating element and contributes to the overall impedance characteristics of the split antenna assembly 300. The gap 303 introduces a discontinuity in the metallic structure, which plays a role in tuning the antenna's impedance and enabling operation across multiple frequency bands. The size and position of the gap 303 are configured to influence the current distribution and radiation pattern of the split antenna assembly 300. The gap 303 also serves as a location for integrating the impedance tuning component 304.

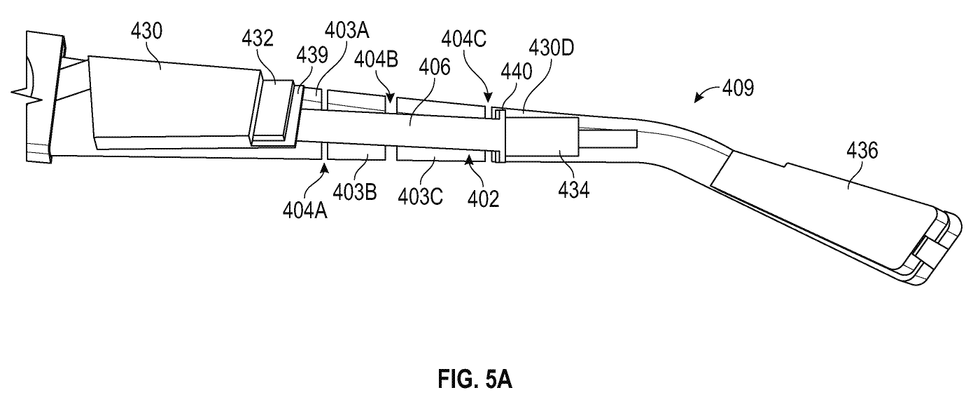

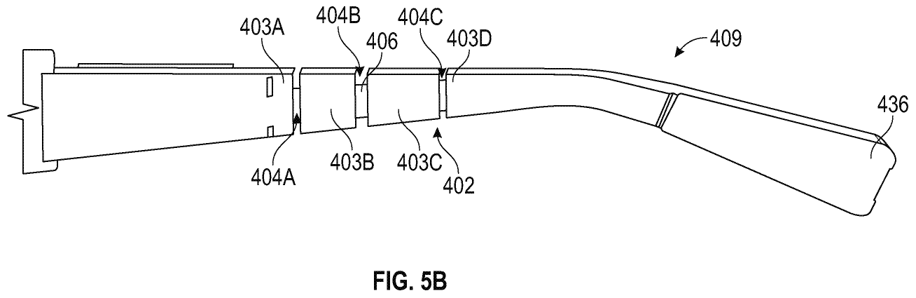

FIG. 5A shows an example of a temple 409 according to another example. The temple 409 can be constructed in a manner similar to the temple 109 or 209 discussed previously in regards to FIGS. 1-4. Portions of the cover of the temple 409 have been removed to show various components including onboard electronics such as the PCB 430 and a communication device 432. FIG. 5A additionally illustrates an antenna 402 (a stripe antenna assembly having a folded dipole antenna configuration) including a first plurality of conductors 402A, 402B, 402C and 402D, a speaker 434 and a battery 436. The temple 402 can carry the antenna 402 therein. The antenna 402 can include a second conductor 406 (e.g., such as the heat transfer device discussed previously in FIGS. 2 or 3, a stiffener, a flexible printed circuit or other suitable electrically conductive component), a first shorting bar 439 and a second shorting bar 440.

As an example, the antenna 402 can be a driven antenna with the antenna 402 including the first plurality of conductors 403A, 403B, 403C and 403D and the second conductor 406 acting as active antenna elements that are electrically connected to the communication device 432 (e.g., a transceiver system) incorporated in the PCB 430. The antenna 402 can be constructed of a metal, metal alloy or other suitable electrically conductive material so as to be operable as the active antenna element. The PCB 230A can be electrically connected to the active antenna element (the antenna 402) at a signal feed (not shown) at or adjacent the first shorting bar 439. Additionally, the temple support or heat transfer device via connection with the first shorting bar 439 and/or the second shorting bar 440 can act as the primary ground plane for antenna 402. According to some examples, the PCB 430, the communication device 432, the speaker 434 and/or the battery 436, which can include conductive metal components, and can be electrical connections to the ground plane or can act as the ground plane.

The first plurality of conductors 403A, 403B, and 403C are metallic segments that form radiating elements of the folded dipole antenna 402. The first plurality of conductors 403A, 403B, and 403C are spaced apart such as at the first gaps 404A, 404B, and 404C, to enable operation at multiple frequency bands. The first plurality of conductors 403A, 403B, and 403C are positioned along the elongate length of the temple 409. The second conductor 406 extends generally in parallel with the first plurality of conductors 403A, 403B, and 403C. The first plurality of conductors 403A, 403B, and 403C interact with the second conductor 406 to create a parallel plate capacitor effect, which is tuned using impedance tuning components (not specifically shown) to achieve a desired frequency response. The first plurality of conductors 403A, 403B, and 403C and the second conductor 406 may be fabricated from materials such as copper, copper alloy, aluminum alloy or aluminum, having dimensions selected to support efficient RF signal propagation.

The first gap 404A, second gap 404B, and third gap 404C are intentional discontinuities between the first plurality of conductors 403A, 403B, and 403C and can be placed in desired location and spacing. The dimension of the first gap 404A, second gap 404B, and third gap 404C can vary relative to one another. The dimension can be between about 0.1 mm and about 2.0 mm according to some examples. These first gaps 404A, 404B, and 404C contribute to the ability of the antenna 402 to operate across multiple frequency bands. By introducing these gaps 404A, 404B, and 404C, the antenna structure is divided into smaller segments, each capable of resonating at specific frequencies. Impedance tuning components (not shown but shown previously and discussed and shown subsequently) can be positioned within these gaps 404A, 404B, and 404C to filter undesired frequencies and control current distribution. The size and placement of the gaps 404A, 404B, and 404C can determined based on the desired frequency bands, with larger gaps supporting lower frequencies and smaller gaps enabling higher frequencies.

The second conductor 406 is a continuous metallic element positioned inward of the first plurality of conductors 403A, 403B, and 403C in a width dimension. The second conductor 406 conductor is relatively closer to the user's head when the eyewear device is worn and acts as a shield or reflector to direct radiated energy outward. The second conductor 406 may be implemented as a vapor chamber, flexible printed circuit, a metallic stiffener, and/or other suitable metallic component depending on the design requirements.

FIG. 5B shows the temple 409 from an opposing side (an exterior or outward facing side) although portions of the cover are removed to show the antenna 402 including the first plurality of conductors 403A, 403B, 403C and 403D, the first gap 404A, the second gap 404B, and the third gap 404C and the second conductor 406 as previously discussed.

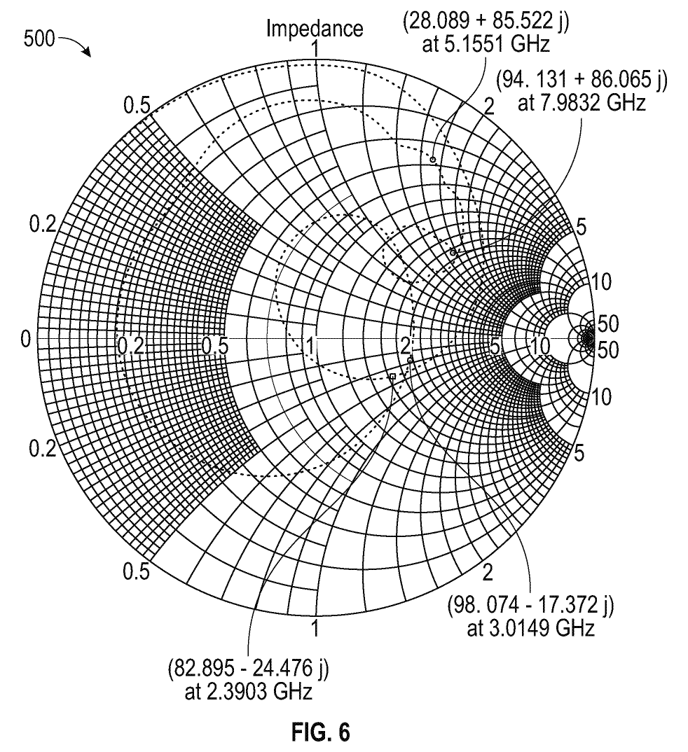

FIG. 6 shows a graph 500 that represents the impedance characteristics of the stripe antenna assembly of FIGS. 5A and 5B across a range of frequencies. This graph 500 (a Smith chart) visualizes complex impedance and reflection coefficients. The data points plotted on the Smith chart correspond to the impedance values of the antenna at specific frequencies. The chart 500 demonstrates a closeness of the impedance points to the center of the Smith chart suggests a favorable match, while points located farther from the center indicate impedance mismatches that may result in decreased efficiency. The graph 500 also shows the antenna's bandwidth, which is the range of frequencies over which the antenna maintains acceptable impedance matching. The graph 500 demonstrates the effectiveness of the antenna of FIGS. 5A and 5B.

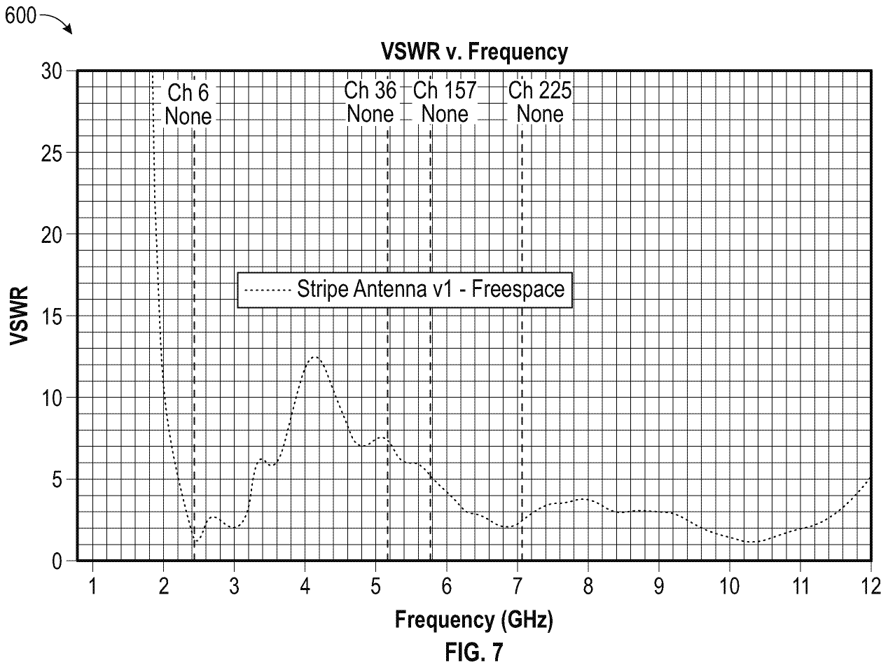

FIG. 7 is a graph 600 of Voltage Standing Wave Ratio (VSWR) of the antenna of FIGS. 5A and 5B and illustrates the performance characteristics of the stripe antenna assembly in terms of impedance matching across a range of frequencies.

The horizontal axis of the graph 600 represents the frequency range, spanning from 1GHz to 12GHz, while the vertical axis represents the VSWR values, ranging from 0 to 30. The curve plotted on the graph corresponds to the performance of the stripe antenna assembly in a free-space environment. The graph highlights specific frequency bands, including WiFi 6E and other wireless communication standards, where the antenna demonstrates optimal performance. For instance, the VSWR values are notably low in the frequency range between 6GHz and 7GHz, indicating efficient radiation and minimal signal loss. This performance is achieved through the strategic design of the folded dipole antenna of FIGS. 5A and 5B, including the placement of impedance tuning components and the configuration of gaps/slits along the metallic sections.

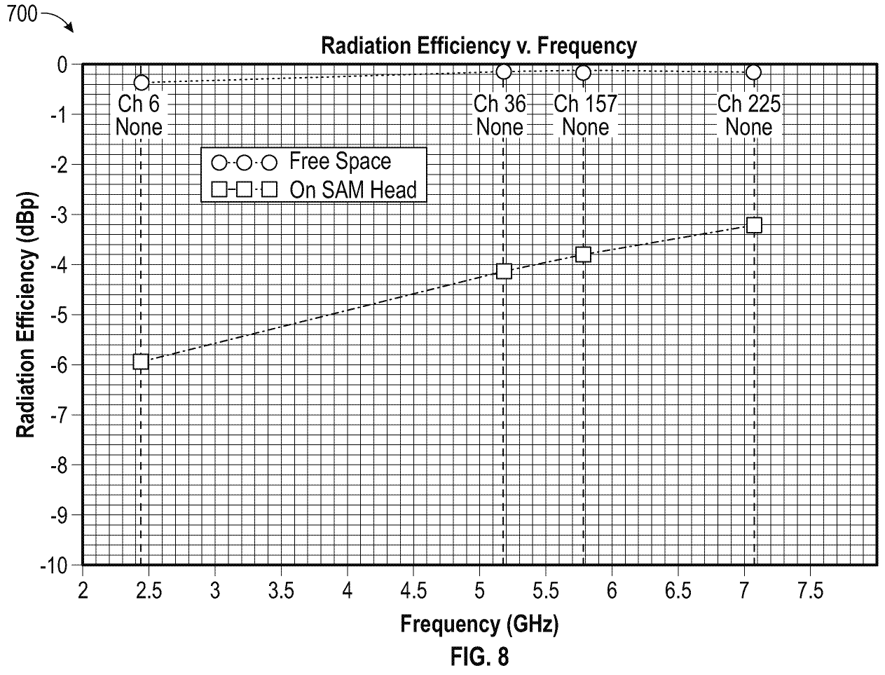

FIG. 8 is a graph 700 illustrates the radiation efficiency of the stripe antenna assembly as a function of frequency under two distinct conditions: in free space and when worn on a Specific Anthropomorphic Mannequin (SAM) head. The graph 700 plays a role in assessing the performance of the antenna of FIGS. 5A and 5B, particularly in scenarios where the proximity to the human head introduces challenges such as electromagnetic energy absorption and efficiency degradation. The graph 700 includes two distinct curves, one representing the radiation efficiency in free space and the other representing the radiation efficiency when worn on the SAM head. The free space curve demonstrates the baseline performance of the stripe antenna assembly, which is characterized by high radiation efficiency across the frequency bands of interest. This curve provides a basis for understanding the antenna's capabilities without external interference from lossy materials such as human tissue. The SAM head curve, on the other hand, provides insights into the antenna's performance when subjected to real-world conditions in proximity to the head.

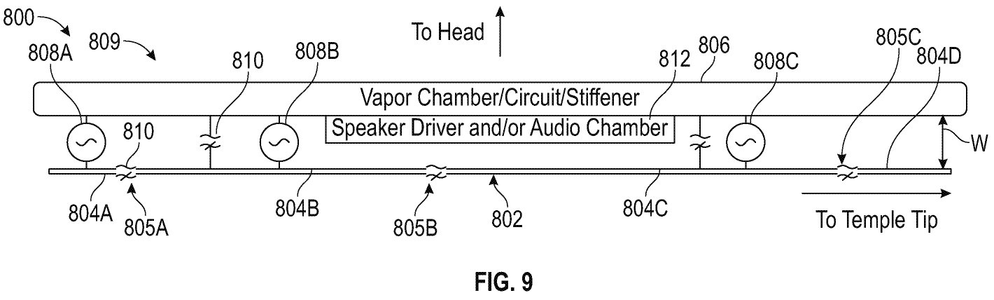

FIG. 9 shows a schematic example of an assembly 800 such as for a temple 809. The assembly 800 can include a folded dipole antenna 802 that can be carried by the temple 809 of the eyewear device. The assembly 800 is designed to house and support the folded dipole antenna 802, impedance tuning components 810, multiple feed points 808A, 808B, and 808C, conductive segments 804A, 804B, 804C, and 804D, gaps 805A, 805B, and 805C, the second conductor 806, and the speaker driver and/or audio chamber 812. The folded dipole antenna 802 includes the conductive segments 804A, 804B, 804C, and 804D, the gaps 805A, 805B, and 805C, the second conductor 806 and the impedance tuning components 810 along with additional components. Although not shown in FIG. 9, the antenna 902 can additionally include a PCB (which can include a communication device), a ground (e.g., the battery) and the first feed point, 808A, second feed point 808B and third feed point 808C.

The feed points 808A, 808B, and 808C are excitation points that connect the folded dipole antenna 802 to different wireless communication systems. Each feed point is electrically coupled to a specific segment of the antenna, allowing the assembly 800 to support multiple frequency bands and communication protocols. For example, one feed point may be dedicated to WiFi communication, while another may support GNSS or cellular signals. The presence of multiple feed points enables the antenna to operate as a multi-band system, providing versatility and enhanced functionality for the AR-capable eyewear device.

FIG. 9 illustrates a width dimension W between the conductive segments 804A, 804B, 804C, and 804D and the second conductor 806. This width dimension W can be between 1.5 mm and 5 mm, for example. As discussed previously, the conductive segments 804A, 804B, 804C, and 804D, are separated by adjacent conductive segments by gaps 805A, 805B, and 805C. The conductive segments 804A, 804B, 804C, and 804D can be electrically connected to the second conductor 806 including by impedance tuning components 810 extending in the width dimension W. The radiating aperture of the antenna (formed between the conductive segments 804A, 804B, 804C, and 804D and the second conductor 806) is positioned orthogonally to the user's head, which facilitates the outward direction of electromagnetic energy and minimizes absorption by head tissue. The folded dipole design supports compact integration within the temple while delivering the electrical characteristics required for effective wireless communication.

The gaps 805A, 805B, and 805C are discontinuities in the metallic structure of the folded dipole antenna 802 that are introduced to enable multi-band operation. These gaps 805A, 805B, and 805C provide for the distinct conductive segments 804A, 804B, 804C, and 804D, each of which is tuned to operate at specific frequency bands. The gaps 805A, 805B, and 805C can be sized and positioned to improve the performance of the folded dipole antenna 802 across a wide range of frequencies. Impedance tuning components 810 can be placed at the gaps 805A, 805B, and 805C as shown in FIG. 9 to manipulate the electrical characteristics of the antenna, ensuring efficient radiation and minimal energy absorption by the user’s head.

The second conductor 806 is a continuous metallic structure positioned inward of the folded dipole antenna 802, closer to the user's head. The second conductor 806 can act as a reflector to direct electromagnetic energy outward and shielding the user's head from radiation. The second conductor 806 may be implemented as a vapor chamber, flexible printed circuit, metallic stiffener, and/or other suitable conductive component as discussed previously. The metal component (e.g., the second conductor 806) can be substantially continuous and extends substantially in parallel with the conductive segments 804A, 804B, 804C, and 804D.

The speaker driver and/or audio chamber 812 can positioned within a width dimension W of the folded dipole antenna 802 and serves as the audio output system for the AR-capable eyewear device. The width dimension W is a width of a radiating aperture that is orthogonal to a head of the user when the smart glasses are worn. The audio chamber can be made of non-conductive material, such as plastic, to avoid interference with electromagnetic fields of the folded dipole antenna 802. The speaker driver generates sound waves, which are directed through the audio chamber to the user’s ear. The placement of the speaker driver and/or audio chamber 812 within the antenna structure allows for efficient use of space within the temple 809 while maintaining the necessary separation from other electronic components.

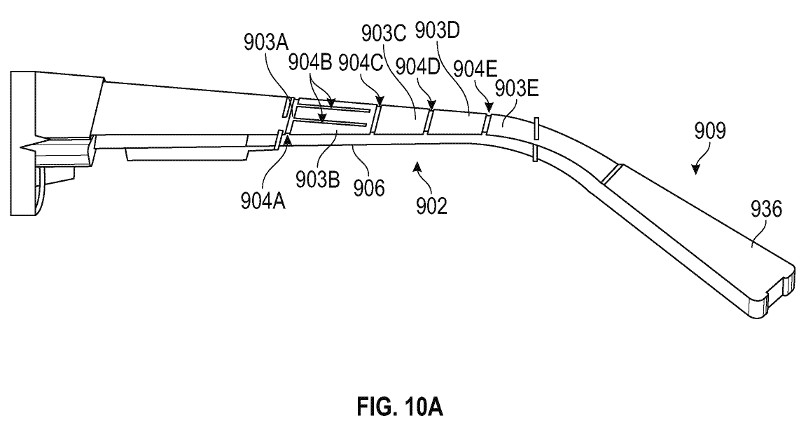

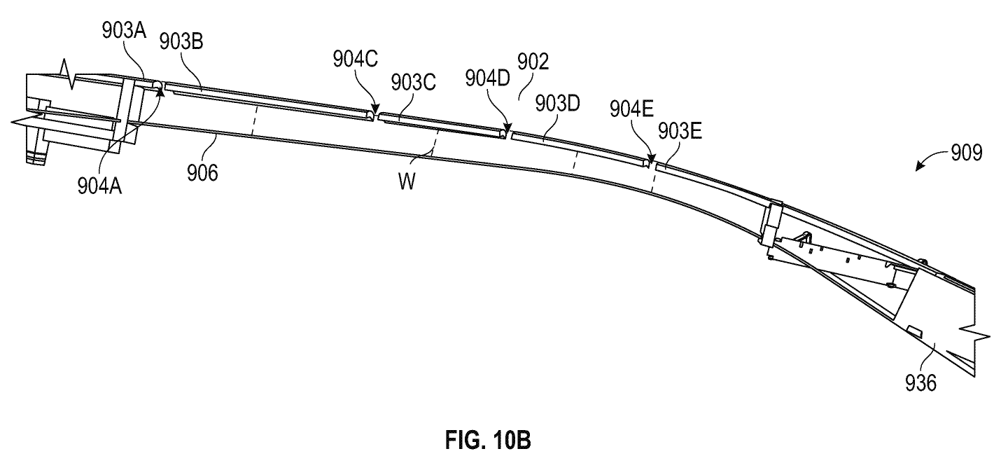

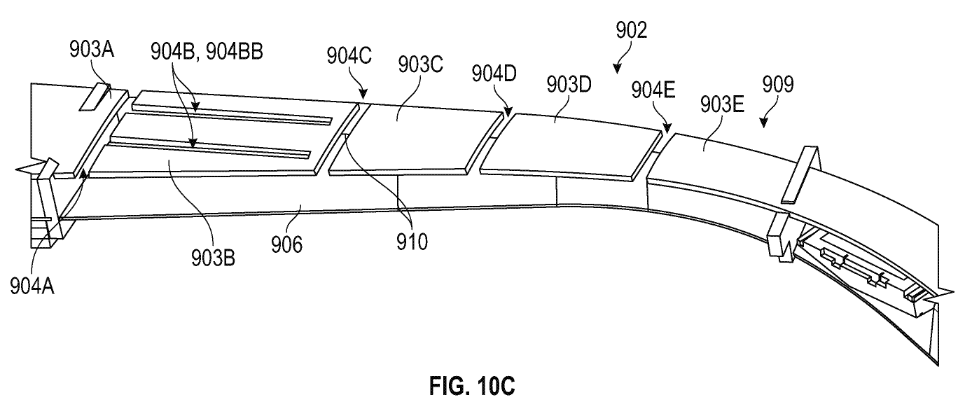

FIGS. 10A-10C show another example of a temple 909 constructed in a similar manner to that of the temple 409 of FIGS. 5A and 5B but with some differences. The temple 909 carries a battery 936 similar to that of the temples discussed previously. As shown in FIGS. 10A-10C, the folded dipole antenna 902 can include a first plurality of conductors 903A-903E, gaps 904A, 904B, 904C, 904D, 904E, a second conductor 906 and impedance tuning components 910 (FIG. 10C only). The folded dipole antenna 902 differs in that antenna utilizes five first plurality of conductors 903A-903E and five gaps 904A, 904B, 904C, 904D, 904E. Furthermore, the configuration of the first plurality of conductors 903A-903E and the gaps 904A, 904B, 904C, 904D, 904E differs from the example of FIGS. 5A and 5B. For example, the plurality of gaps 904A, 904B, 904C, 904D, 904E extend with a major dimension generally orthogonal to the width dimension W (FIG. 10B) and the elongate length (extending along the temple 909 from the frame to the battery 936). The gap 904B can be one or more slits 904BB (FIG. 10C) that extend along the conductor 903B. The one or more slits 904BB (FIG. 10C) can extend with a major dimension that is generally aligned with the elongate length (although other orientations are contemplated). In contrast, the gaps 904A, 904C, 904D and 904E can extend with a major dimension generally orthogonal to the width dimension and the elongate length (orthogonal to the one or more slits 904BB).

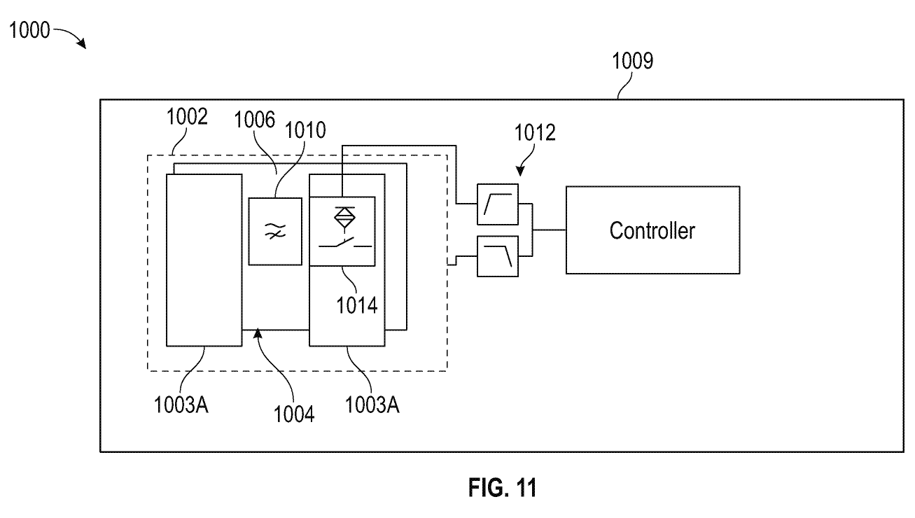

FIG. 11 is a schematic view of an eyewear device 1000 including the folded dipole assembly 1002 that can be carried by the temple 1009. The eyewear device 1000 integrates functionalities, such as wireless communication and capacitive touch sensing, within the compact form factor of the temple 1009. The eyewear device 1000 incorporates a controller that can be configured to control the operation of the various components, including a diplexer 1012 and a capacitive touch sensor 1014, to support such the functionality.

The folded dipole antenna 1002 can include a first conductive segment 1003A, a second conductive segment 1003B, a second conductor 1006, a gap 1004 as previously discussed. The impedance tuning component 1010 can be positioned in the gap 1004 as previously discussed. The capacitive touch sensor 1014 can be integrated into the temple 1009 and electrically coupled to the folded dipole antenna 1002 (e.g., electrically coupled to the first conductive segment 1003A, the second conductive segment 1003B or another component). The capacitive touch sensor 1014 can connected via the diplexer 1012. The capacitive touch sensor 1014 can be configured to detect touch gestures on the surface of the temple 1009, such as taps, swipes, or finger movements between the conductive segments 1003A, 1003B of the folded dipole antenna 1002. In one example, the capacitive touch sensor 1014 is configured to detect at least one of: forward swipe gestures, backward swipe gestures, and tap gestures. The capacitive touch sensor 1014 can be configured to detect changes in capacitance caused by user interaction to determine the type of gesture performed. These gestures can be used to control various functions of the eyewear device 1000, such as muting/unmuting speakers, skipping audio tracks, or accepting/declining voice calls.

The capacitive touch sensor 1014 can be located at or adjacent the gap 1004, for example. Thus, the capacitive touch sensor 1014 can be configured to detect when a finger taps and bridges between two adjacent of the first plurality of conductors 1003A, 1003B as the capacitive touch sensor 1014 is configured to detect a change a response of the folded dipole antenna when the finger bridges the two adjacent of the first plurality of conductors 1003A, 1003B.

The diplexer 1012 can be configured to route high-frequency RF signals to and from the folded dipole antenna 1002 for wireless communication and configured to route low-frequency signals to and from the capacitive touch sensor 1014 for gesture detection. This diplexer 1012 can be configured to separate the two types of signals, allowing for RF performance of the folded dipole antenna 1002 and the capacitive touch sensing functionality described. The diplexer 1012 can work in conjunction with the controller of the eyewear device 1000 to coordinate operations of the folded dipole antenna 1002 and the capacitive touch sensor 1014, facilitating smooth integration of communication and user interaction features.

Note that although the disclosure herein of a device that incorporates antenna systems, as disclosed, is directed primarily to the example of an eyewear device, antenna systems as disclosed may in other examples be incorporated in different types of electronic devices. Thus, for example, the disclosed antenna systems can be profitably employed in other wearable electronic devices, mobile electronic devices (such as mobile phones, tablets, or the like), and/or larger products such as motor vehicles or the like.

The foregoing description includes devices, systems techniques, instruction sequences, and computing machine program products that embody illustrative examples of the disclosure. In the above description, for the purposes of explanation, numerous specific details are set forth in order to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific examples, various modifications and changes may be made to these examples without departing from the broader scope of examples of the present disclosure. Such examples of the inventive subject matter may be referred to herein, individually or collectively, by the term “invention” merely for convenience and without intending to voluntarily limit the scope of this application to any single disclosure or inventive concept if more than one is, in fact, disclosed.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present disclosure as represented by the appended claims. The specification and drawings are, accordingly, to be regarded in an illustrative rather than a restrictive sense.

The following numbered examples is a non-exhaustive list of selected illustrative examples in accordance with various aspects of the present disclosure.

### CLAIMS RELATED EXAMPLES

Example 1 is a smart glasses optionally comprising: an eyewear frame defining one or more optical element holders for holding respective optical elements within view of a user when the smart glasses are worn; a pair of temples connected to the eyewear frame for supporting the eyewear frame in position within view of the user when the smart glasses are worn; and a stripe antenna assembly carried by at least one of the pair of temples, the stripe antenna assembly comprising: a first plurality of conductors arranged along an elongate length of the at least one of the pair of temples, wherein each of the first plurality of conductors is spaced from an adjacent one of the first plurality of conductors by a gap; a second conductor positioned inward of the first plurality of conductors in a width dimension so as to be relatively closer adjacent the user when the smart glasses are worn; and one or more impedance tuning components, wherein the one or more impedance tuning components are at least one of: positioned along the elongate length of the stripe antenna assembly at the gap between adjacent of the first plurality of conductors and positioned to extend in the width dimension between one or more of the first plurality of conductors and the second conductor.

In Example 2, the subject matter of Example 1 optionally includes, wherein the stripe antenna assembly comprises a folded dipole antenna having a radiating aperture that is orthogonal to a head of the user when the smart glasses are worn.

In Example 3, the subject matter of Examples 1–2 optionally includes, at least one of a speaker driver and a non-conductive audio chamber, wherein one or both of the speaker driver and the non-conductive audio chamber is positioned in the width dimension between the second conductor and at least one of the first plurality of conductors.

In Example 4, the subject matter of Examples 1–3 optionally includes, where in the second conductor is continuous along the elongate length of the first plurality of conductors, and wherein the second conductor is at least one of a vapor chamber, a flexible printed circuit, a metallic stiffener or other suitable metallic component.

In Example 5, the subject matter of Example 4 optionally includes, wherein the flexible printed circuit is electrically connected to the vapor chamber, and wherein the flexible printed circuit and vapor chamber together form the second conductor.

In Example 6, the subject matter of Examples 4–5 optionally includes, wherein the flexible printed circuit is configured to carry at least one of power and high frequency signals.

In Example 7, the subject matter of Examples 1–6 optionally includes, wherein the one or more impedance tuning components are one or more filters configured to filter specific frequencies and control current distribution along the stripe antenna assembly.

In Example 8, the subject matter of Examples 1–7 optionally includes, wherein the first plurality of conductors are separated by a plurality of gaps including the gap, wherein the plurality of gaps extend with a major dimension generally orthogonal to the width dimension and the elongate length, wherein the plurality of gaps are located to enable operation at multiple frequency bands, wherein a number of the plurality of gaps is determined based on a number of frequency bands to be supported.

In Example 9, the subject matter of Example 8 optionally includes one or more slits that extend along at least one of the first plurality of conductors.

In Example 10, the subject matter of Example 9 includes, wherein the one or more slits extend with a major dimension that is generally aligned with the elongate length.

In Example 11, the subject matter of Examples 1–10 optionally includes, a capacitive touch sensor positioned at or adjacent the gap and configured to detect touch gestures on the at least one of the pair of temples adjacent the gap, and wherein the capacitive touch sensor is configured to detect finger movement between the first plurality of conductors of the stripe antenna assembly.

In Example 12, the subject matter of Examples 1–11 optionally includes, wherein the stripe antenna assembly includes multiple excitation points, each excitation point connected to a different wireless communication system.

Example 13 is an eyewear device configured for electronic communication, the eyewear device optionally comprising: an eyewear frame defining one or more optical element holders for holding respective optical elements within view of a user when the eyewear device is worn; a pair of temples connected to the eyewear frame for supporting the eyewear frame in position within view of the user when the eyewear device is worn; and a folded dipole antenna carried by at least one of the pair of temples, the folded dipole antenna having a radiating aperture that is orthogonal to a head of the user when the eyewear device is worn, the folded dipole antenna comprising: a first plurality of conductive segments spaced apart from one another along an elongate length of the at least one of the pair of temples; an second conductive segment positioned inward of the first plurality of conductive segments in a width dimension so as to be relatively closer adjacent the user when the eyewear device is worn; and one or more impedance tuning components, wherein the one or more impedance tuning components are at least one of: electrically coupled to the first plurality of conductive segments and electrically coupled to one or more of the first plurality of conductive segments and the second conductive segment.

In Example 14, the subject matter of Example 13 optionally includes, where in the second conductive segment is continuous along the elongate length of the first plurality of conductive segments, and wherein the second conductive segment is at least one of a vapor chamber, a flexible printed circuit, a metallic stiffener or other suitable metallic component.

In Example 15, the subject matter of Examples 13–14 optionally includes, wherein the first plurality of conductive segments are separated by a plurality of gaps, wherein the plurality of gaps extend with a major dimension generally orthogonal to the width dimension and the elongate length, wherein the plurality of gaps are located to enable operation at multiple frequency bands, wherein a number of the plurality of gaps is determined based on a number of frequency bands to be supported.

In Example 16, the subject matter of Example 15 optionally includes, one or more slits that extend along at least one of the first plurality of conductive segments, wherein the one or more slits extend with a major dimension that is generally aligned with the elongate length.

In Example 17, the subject matter of Examples 15–16 optionally includes, a capacitive touch sensor positioned adjacent or between one or more of the plurality of gaps and configured to detect touch gestures on the at least one of the pair of temples adjacent the one or more of the plurality of gaps, and wherein the capacitive touch sensor is configured to detect finger movement between the first plurality of conductive segments.

Example 18 is an electronics enabled eyewear device, optionally comprising: a folded dipole antenna carried by a temple of the eyewear device, the folded dipole antenna comprising: a first plurality of conductors having a gap between adjacent of the first plurality of conductors; a second conductor positioned inward of the first plurality of conductors in a width direction so as to be relatively closer adjacent a user when the eyewear device is worn; and a plurality of impedance tuning components distributed along an elongate length of the folded dipole antenna; a diplexer coupled to the folded dipole antenna and configured to route high frequency RF signals to and from the folded dipole antenna for wireless communications and route low frequency signals to and from the folded dipole antenna for capacitive touch sensing; and a capacitive touch sensor coupled to the diplexer and configured to detect touch gestures on a surface of the temple.

In Example 19, the subject matter of Example 18 optionally includes, wherein the capacitive touch sensor is configured to detect when a finger taps and forms a bridge between two adjacent of the first plurality of conductors, and wherein the capacitive touch sensor is configured to detect a change a response of the folded dipole antenna when the finger bridges the two adjacent of the first plurality of conductors.

In Example 20, the subject matter of Examples 18–19 optionally includes, wherein the capacitive touch sensor is configured to detect at least one of: forward swipe gestures, backward swipe gestures, and tap gestures.

In Example 21, the subject matter of Examples 18–20 optionally includes, a controller configured to control functions of the eyewear device based on detected touch gestures, wherein the functions comprise at least one of: muting speakers, unmuting speakers, skipping audio tracks, accepting voice calls, and declining voice calls.

Example 22 is a method for operating an electronics enabled eyewear device, the method optionally comprising: transmitting and receiving high frequency RF signals via a folded dipole antenna carried by a temple of the eyewear device; detecting, via a capacitive touch sensor coupled to the folded dipole antenna through a diplexer, changes in capacitance when a user touches a surface of the temple; determining a type of touch gesture based on changes in capacitance from the detecting; and controlling a function of the eyewear device based on the determining the type of the touch gesture.

In Example 23, the subject matter of Example 22 optionally includes, positioning the capacitive touch sensor at a gap adjacent or between a first conductive segment and a second conductive segment of the folded dipole antenna, and wherein the detecting includes detecting changes in capacitance when a finger bridges the first conductive segment and the second conductive segment.

In Example 24, the subject matter of Examples 22–23 optionally includes, wherein the type of touch gesture comprises at least one of: a forward swipe, a backward swipe, and a tap.

In Example 25, the subject matter of Examples 22–24 optionally includes, wherein controlling the function of the eyewear device comprises at least one of: muting speakers, unmuting speakers, skipping audio tracks, accepting voice calls, and declining voice calls.

Example 26 is at least one machine-readable medium including instructions that, when executed by processing circuitry, cause the processing circuitry to perform operations to implement of any of Examples 1–25.

Example 27 is an apparatus comprising means to implement of any of Examples 1–25.

Example 28 is a system to implement of any of Examples 1–25.

Example 29 is a method to implement of any of Examples 1–25.

1. A smart glasses comprising:
an eyewear frame defining one or more optical element holders for holding respective optical elements within view of a user when the smart glasses are worn;
a pair of temples connected to the eyewear frame for supporting the eyewear frame in position within view of the user when the smart glasses are worn; and
a stripe antenna assembly carried by at least one of the pair of temples, the stripe antenna assembly comprising:
a first plurality of conductors arranged along an elongate length of the at least one of the pair of temples, wherein each of the first plurality of conductors is spaced from an adjacent one of the first plurality of conductors by a gap;
a second conductor positioned inward of the first plurality of conductors in a width dimension so as to be relatively closer adjacent the user when the smart glasses are worn; and
one or more impedance tuning components, wherein the one or more impedance tuning components are at least one of: positioned along the elongate length of the stripe antenna assembly at the gap between adjacent of the first plurality of conductors and positioned to extend in the width dimension between one or more of the first plurality of conductors and the second conductor.

2. The smart glasses of claim 1, wherein the stripe antenna assembly comprises a folded dipole antenna having a radiating aperture that is orthogonal to a head of the user when the smart glasses are worn.

3. The smart glasses of claim 1, further comprising at least one of a speaker driver and a non-conductive audio chamber, wherein one or both of the speaker driver and the non-conductive audio chamber is positioned in the width dimension between the second conductor and at least one of the first plurality of conductors.

4. The smart glasses of claim 1, where in the second conductor is continuous along the elongate length of the first plurality of conductors, and wherein the second conductor is at least one of a vapor chamber, a flexible printed circuit, a metallic stiffener or other suitable metallic component.

5. The smart glasses of claim 4, wherein the flexible printed circuit is electrically connected to the vapor chamber, and wherein the flexible printed circuit and vapor chamber together form the second conductor.

6. The smart glasses of claim 4, wherein the flexible printed circuit is configured to carry at least one of power and high frequency signals.

7. The smart glasses of claim 1, wherein the one or more impedance tuning components are one or more filters configured to filter specific frequencies and control current distribution along the stripe antenna assembly.

8. The smart glasses of claim 1, wherein the first plurality of conductors are separated by a plurality of gaps including the gap, wherein the plurality of gaps extend with a major dimension generally orthogonal to the width dimension and the elongate length, wherein the plurality of gaps are located to enable operation at multiple frequency bands, wherein a number of the plurality of gaps is determined based on a number of frequency bands to be supported.

9. The smart glasses of claim 8, further comprising one or more slits that extend along at least one of the first plurality of conductors.

10. The smart glasses of claim 9, wherein the one or more slits extend with a major dimension that is generally aligned with the elongate length.

11. The smart glasses of claim 1, further comprising a capacitive touch sensor positioned at or adjacent the gap and configured to detect touch gestures on the at least one of the pair of temples adjacent the gap, and wherein the capacitive touch sensor is configured to detect finger movement between the first plurality of conductors of the stripe antenna assembly.

12. The smart glasses of claim 1, wherein the stripe antenna assembly includes multiple excitation points, each excitation point connected to a different wireless communication system.

13. An eyewear device configured for electronic communication, the eyewear device comprising:
an eyewear frame defining one or more optical element holders for holding respective optical elements within view of a user when the eyewear device is worn;
a pair of temples connected to the eyewear frame for supporting the eyewear frame in position within view of the user when the eyewear device is worn; and
a folded dipole antenna carried by at least one of the pair of temples, the folded dipole antenna having a radiating aperture that is orthogonal to a head of the user when the eyewear device is worn, the folded dipole antenna comprising:
a first plurality of conductive segments spaced apart from one another along an elongate length of the at least one of the pair of temples;
an second conductive segment positioned inward of the first plurality of conductive segments in a width dimension so as to be relatively closer adjacent the user when the eyewear device is worn; and
one or more impedance tuning components, wherein the one or more impedance tuning components are at least one of: electrically coupled to the first plurality of conductive segments and electrically coupled to one or more of the first plurality of conductive segments and the second conductive segment.

14. The eyewear device of claim 13, where in the second conductive segment is continuous along the elongate length of the first plurality of conductive segments, and wherein the second conductive segment is at least one of a vapor chamber, a flexible printed circuit, a metallic stiffener or other suitable metallic component.

15. The eyewear device of claim 13, wherein the first plurality of conductive segments are separated by a plurality of gaps, wherein the plurality of gaps extend with a major dimension generally orthogonal to the width dimension and the elongate length, wherein the plurality of gaps are located to enable operation at multiple frequency bands, wherein a number of the plurality of gaps is determined based on a number of frequency bands to be supported.

16. The eyewear device of claim 15, further comprising one or more slits that extend along at least one of the first plurality of conductive segments, wherein the one or more slits extend with a major dimension that is generally aligned with the elongate length.

17. The eyewear device of claim 15, further comprising a capacitive touch sensor positioned adjacent or between one or more of the plurality of gaps and configured to detect touch gestures on the at least one of the pair of temples adjacent to? the one or more of the plurality of gaps, and wherein the capacitive touch sensor is configured to detect finger movement between the first plurality of conductive segments.

18. An electronics enabled eyewear device, comprising:
a folded dipole antenna carried by a temple of the eyewear device, the folded dipole antenna comprising:
a first plurality of conductors having a gap between adjacent of the first plurality of conductors;
a second conductor positioned inward of the first plurality of conductors in a width direction so as to be relatively closer adjacent a user when the eyewear device is worn; and
a plurality of impedance tuning components distributed along an elongate length of the folded dipole antenna;
a diplexer coupled to the folded dipole antenna and configured to route high frequency RF signals to and from the folded dipole antenna for wireless communications and route low frequency signals to and from the folded dipole antenna for capacitive touch sensing; and
a capacitive touch sensor coupled to the diplexer and configured to detect touch gestures on a surface of the temple.

19. The eyewear device of claim 18, wherein the capacitive touch sensor is configured to detect when a finger taps and forms a bridge between two adjacent of the first plurality of conductors, and wherein the capacitive touch sensor is configured to detect a change a response of the folded dipole antenna when the finger bridges the two adjacent of the first plurality of conductors.

20. The eyewear device of claim 18, wherein the capacitive touch sensor is configured to detect at least one of: forward swipe gestures, backward swipe gestures, and tap gestures, further comprising a controller configured to control functions of the eyewear device based on detected touch gestures, wherein the functions comprise at least one of: muting speakers, unmuting speakers, skipping audio tracks, accepting voice calls, and declining voice calls.
